(19) United States
(12) Patent Application Publication
(10) Pub. No.: US 2009/0081621 A1
(43) Pub. Date: Mar. 26, 2009

(54) Methods And Systems For Personalizing A Display Board Featuring A Product For Professional Presentations

(76) Inventor: David Harrison, Denville, NJ (US)

Correspondence Address: BAKER BOTTS L.L.P., 30 ROCKEFELLER PLAZA, 44TH FLOOR, NEW YORK, NY, 10112-4498, US

(21) Appl. No.: 12/233,728

(22) Filed: Sep. 19, 2008

Related U.S. Application Data
(60) Provisional application No. 60/973,894, filed on Sep. 20, 2007.

(51) Int. Cl. G09F 7/02; G09F 5/00

(52) U.S. Cl. 434/74; 434/429

(57) ABSTRACT

Systems and methods of personalizing a display board featuring a product for professional presentations are provided. The disclosed subject matter comprises a display board, a product mounted to the board, a holder attached to the display board, and a card inserted into the holder.

### CROSS-REFERENCE TO RELATED APPLICATIONS

This application claims priority to U.S. Provisional Application Ser. No. 60/973,894, filed Sep. 20, 2007, which is hereby incorporated by reference in its entirety.

### BACKGROUND OF THE INVENTION

The disclosed subject matter related to methods and systems for personalizing a display board featuring a product for professional presentations.

Display boards are important marketing tools for selling certain products, typically substantially planar products that can be mounted to a board and where color and texture are important characteristics. Examples of such products include roofing shingles, floor tiles, and carpeting. In order for the buyer to accurately assess these products, the buyer must be able to see and touch samples of them.

Often times, the manufacturer of these products may create display boards to assist contractors, distributors or other sales personnel in selling the product. The sales personnel can then use these display boards with potential buyers. Often, the potential purchasers will borrow the display board to enable them to evaluate the product in their home and accordingly make a purchasing decision.

Often, sellers of the same product have to compete with each other to obtain buyers, thereby creating a need to personalize the product and related sales tools in some way to distinguish themselves from the other sellers. If the product is not personalized by the seller, an interested buyer may approach another seller, or vice versa, to purchase the product. The result would be a great deal of wasted effort on behalf of the seller in pitching the product to the potential buyer.

The current techniques for personalizing product information brochures, for example new car brochures, include stapling, paper clipping, or taping a business card to the brochure. That method does not yield results that appear very professional, because the business card may be easily and inadvertently detached from the brochure.

On of the current techniques to personalize a display board include handing out business cards while showing the display board (this method has the drawback of decoupling the seller's information from the display board). The buyer may misplace the business card, and if the buyer has met with several sellers of the same or similar products, the buyer may not remember to whom the board belongs. Another method of personalizing a display board is to apply a pre-printed adhesive label that identifies the seller. This method requires the seller to invest in special labels with his/her company information, an investment which many sellers will not make.

Unfortunately, the current techniques are limited in the ability to personalize a display board featuring a product for professional presentations. Such limitations arise from a failure to use techniques that couple the seller's business information to the manufactured product in a professional, easily achieved manner. Accordingly, there exists a need for a technique to personalize a display board featuring a product, typically a planar product, for professional presentations.

### SUMMARY OF THE INVENTION

The disclosed subject matter are systems and methods for personalizing a display board featuring a product for professional presentations. The methods were developed in response to a need to provide an effective method to personalize a product display board such that the buyer would associate the product with the seller. In addition, the methods provide an overall professional appearance for the display board.

In some embodiments, the method of personalizing a display board featuring a product for professional presentations includes obtaining a display board, attaching a holder, such as a plastic sleeve, to the display boarding, and sliding a business card into the plastic sleeve.

In other embodiments, the method of producing display boards, which can be individualized, featuring a product for professional presentations includes obtaining a display board with a featured product and attaching a holder, such as a plastic sleeve, to the display board. This display board with the plastic sleeve can easily be individualized by sliding a business card into the sleeve.

In another embodiment, the apparatus for personalizing a display board featuring a product for professional presentations includes a product display board, a holder attached to the display board, and a card, which can be inserted into the holder.

The accompanying drawings, which are incorporated and constitute part of the disclosure, illustrate preferred embodiments of the disclosed subject matter and serve to explain its principles.

### BRIEF DESCRIPTION OF THE DRAWINGS

FIG. 1 is a diagram illustrating a method implemented in accordance with some embodiments of the disclosed subject matter; and

FIG. 2 is a block diagram of a system in accordance with some embodiments of the disclosed subject matter.

FIG. 3 is a block diagram of an apparatus in accordance with a preferred embodiment of the disclosed subject matter.

While the disclosed subject matter will now be described in detail with reference to the Figs., it is done so in connection with the illustrative embodiments.

### DETAILED DESCRIPTION

Systems and methods of personalizing a display board featuring a product for professional presentations are provided. One practicing the invention obtains a display board with a product mounted thereon, attaches a holder to the display board, and inserts a card into the holder.

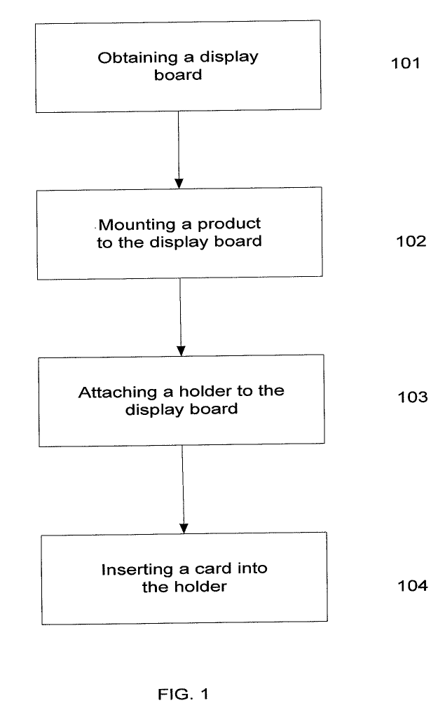

FIG. 1 is diagram illustrating a method implemented in accordance with some embodiments of the disclosed subject matter. A display board is obtained 101. A display board can include any board or device used to display a product. Products that can be displayed on the display board by mounting them to the board include, but are not limited to, carpet samples, floor tiles, roofing shingles and any other substantially planar product where color and texture are important 102.

A holder is attached to the display board 103. The holder can include, but is not limited to, a plastic sleeve, a clip, a hook, slits that are cut into the board, or any other method or device that can hold a business card to the display board.

A card is inserted into the holder 104. The card can include, but is not limited to, a business card or any other card that identifies the seller or provides information on how to contact the seller. The card may contain the seller's personal and/or business information.

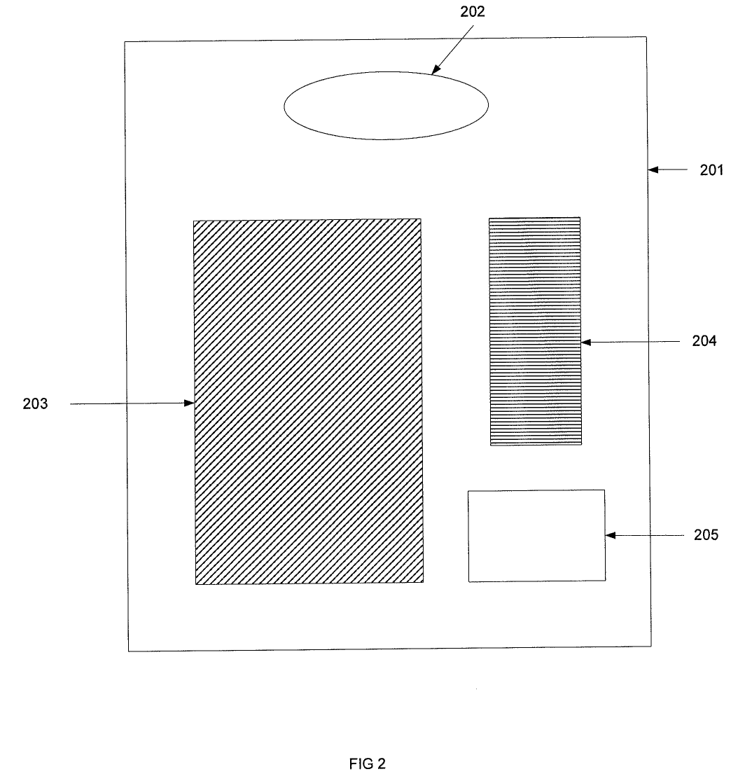

FIG. 2 is a block diagram of an apparatus in accordance with some embodiments of the disclosed subject matter. In a preferred embodiment, the display board 201 is used to display the product and relevant information associated with the product. The display board can include any board or device that can be used to display a product.

The display board can include a handle 202 to facilitate transportation of the display board. The handle makes it easier for the seller to carry and show the display board to various buyers.

The display board can include a sample product 203. The sample product can include any item that can assist the buyer in evaluating the product. In an embodiment, for example, the sample product can include roofing shingles, floor tiles, or carpet samples. The opportunity to see and touch the product can assist the buyer in the decision to purchase the product.

The display board can include a written description of the product 204. The written description can include relevant facts, surveys, opinions, and pictures related to the product.

The display board can include a holder 205. The function of the holder is to hold a card, such as a business card, to the display board. The holder can include, but is not limited to, a plastic sleeve, a clip, a hook, slits that are cut into the board, or any other method or device that can hold a business card to the display board.

A card (not shown) can be inserted into the holder. The card can include, but is not limited to, a business card or any other card that identifies the seller or provides information on how to contact the seller. The card may contain the seller's personal and/or business information.

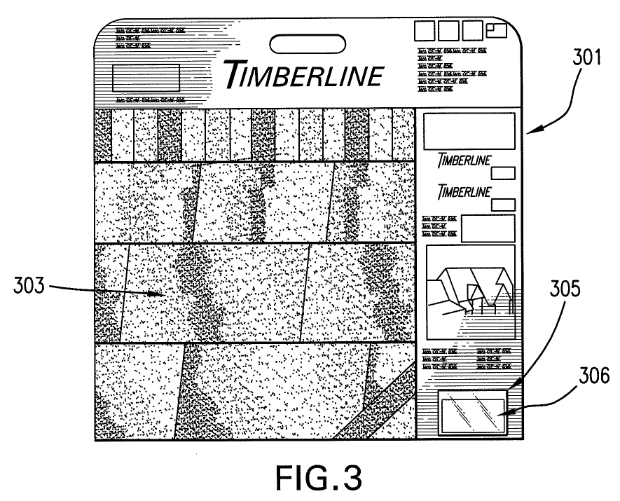

FIG. 3 is a diagram of an apparatus in accordance with a preferred embodiment of the disclosed subject matter. The display board 301 is used to display the product, in particular roofing shingles 303, and relevant information associated with the product. As shown in FIG. 3, the display board for roofing shingles can include a holder 305. The function of the holder is to hold a card, such as a business card 306, to the display board. In the figure, the holder 305 is a plastic sleeve. A business card 306 can be inserted into the plastic sleeve holder 305.

What is claimed is:

1. A method of personalizing a display board featuring a product for professional presentations, comprising:
(a) obtaining a display board;
(b) mounting a product to said display board;
(c) attaching a holder to said display board; and
(d) inserting a card into said holder.

2. The method of claim 1, wherein said holder comprises a plastic sleeve.

3. The method of claim 1, wherein said card comprises a business card.

4. The method of claim 1, wherein the product is substantially planar.

5. The method of claim 1, wherein the product is roofing shingles.

6. An apparatus for personalizing a display board featuring a product for professional presentations, comprising:
(a) a display board with a product mounted thereon;
(b) a holder, attached to said display board; and
(c) a card, which can be inserted into said holder.

7. The apparatus of claim 6, wherein said holder comprises a plastic sleeve.

8. The apparatus of claim 6, wherein said card comprises a business card.

9. The apparatus of claim 6, wherein the product is substantially planar.

10. The apparatus of claim 6, wherein the product is roofing shingles.
